(19) United States
(12) Patent Application Publication
(10) Pub. No.: US 2009/0312189 A1
(43) Pub. Date: Dec. 17, 2009

(54) Method of evaluating pharmacological activity

(75) Inventor: Sterling W. Thomas, Midlothian, VA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: MIDWEST PROTEOMICS, INC., Richmond, VA (US)

(21) Appl. No.: 12/157,841

(22) Filed: Jun. 13, 2008

(51) Int. Cl. C40B 30/00; G06G 7/60; G06G 7/58

(52) U.S. Cl. 506/7; 703/11

(57) ABSTRACT

The disclosure provides a method of evaluation pharmacological activity of a compound, such as a drug candidate, which method combines computational bioinformatics with laboratory validation. In an embodiment, the method involves the creation of a network based on correlation coefficients calculated from a data set generated by exposing the compound to a biological model and gene-against-gene clustering. The network is then validated against, for example, a standard network based on natural language searching. The validated interactions are then run through a simulation scheme to develop a hierarchy of genes that are affected by the compound and that control genes in the network. Laboratory validation is conducted on any gene interactions that could not be otherwise validated. In one embodiment, the final results are compiled into a searchable database.

### RELATED APPLICATION

This application claims priority to U.S. Provisional Patent Application No. 60/934,415 filed on Jun. 13, 2007.

### FIELD OF THE DISCLOSURE

The disclosure relates to the pre-clinical drug development in general and in particular relates to the pre-clinical evaluation of the pharmacological activity of potential drug candidates.

### BACKGROUND OF THE DISCLOSURE

Pre-clinical evaluation of potential drug candidates is an important step in the drug development process. The pre-clinical period is generally that point in time when a drug candidate is evaluated for efficacy, toxicity and other properties before it enters clinical trials, during which it is administered to humans under tightly controlled conditions.

An early step in a pre-clinical evaluation is to determine what activity the subject compound has, or is likely to have, on the intended recipient, such as a human. More particularly, it is advantageous to identify the organs, tissues, metabolic pathways or biological processes that are affected by the compound. These affects are important, not only to identify potential uses of the compound, but also to identify potential toxic effects that it may present. It is estimated that up to 60% of potential drug candidates that fail the clinical stage do so because of toxicity or negative pharmacokinetic interactions. Early prediction of such ill effects, before a compound reaches the clinical stage, can result in significant reduction in human exposure as well as substantial conservation of research effort and other resources involved in clinical stage evaluations.

For numerous reasons, it is beneficial to utilize in vivo methods wherever possible to identify the therapeutic and/or toxic affects that a drug candidate may possess. Accordingly, several methods have been proposed as a means of predicting the affects of various compounds in the human body. In particular, bioinformatics software tools have been developed. Examples of such bioinformatics software tolls include Ingenuity Pathway Analysis® (available from Ingenuity Systems) and Pathway Studio® (available from Ariadne Genomics). While these known bioinformatics systems are quite useful, they do not offer the level of accuracy and predictability that are needed at the pre-clinical stage. In particular, these known computational bioinformatics tools rely on databases that are developed through natural language searching of published literature and thus lack an important independent validation component.

### SUMMARY OF THE DISCLOSURE

The disclosure provides, in one embodiment, a method of evaluating the pharmacological activity of a compound comprising the use of computational bioinformatics in combination with laboratory validation.

### BRIEF DESCRIPTION OF THE DRAWING

FIG. 1 is a flow diagram of a method consistent with an embodiment of the disclosure.

### DETAILED DESCRIPTION

The disclosure provides a method of evaluating the pharmacological activity of a compound at a pre-clinical stage comprising the use of computational bioinformatics in combination with laboratory validation. The method can be used to identify possible targets, toxic side effects and optimal dosage using computational bioinformatics combined with laboratory validation. The method is useful to evaluate compounds proposed as drug candidates.

Bioinformatics, as used herein and as generally understood in the art, refers to the creation and advancement of algorithms, computational techniques, statistical techniques, and theory to solve formal and practical problems arising from the management and analysis of biological data. Laboratory analysis or validation, as used herein and generally understood, refers to biological or pharmacological activities and tests using traditional laboratory equipment and techniques.

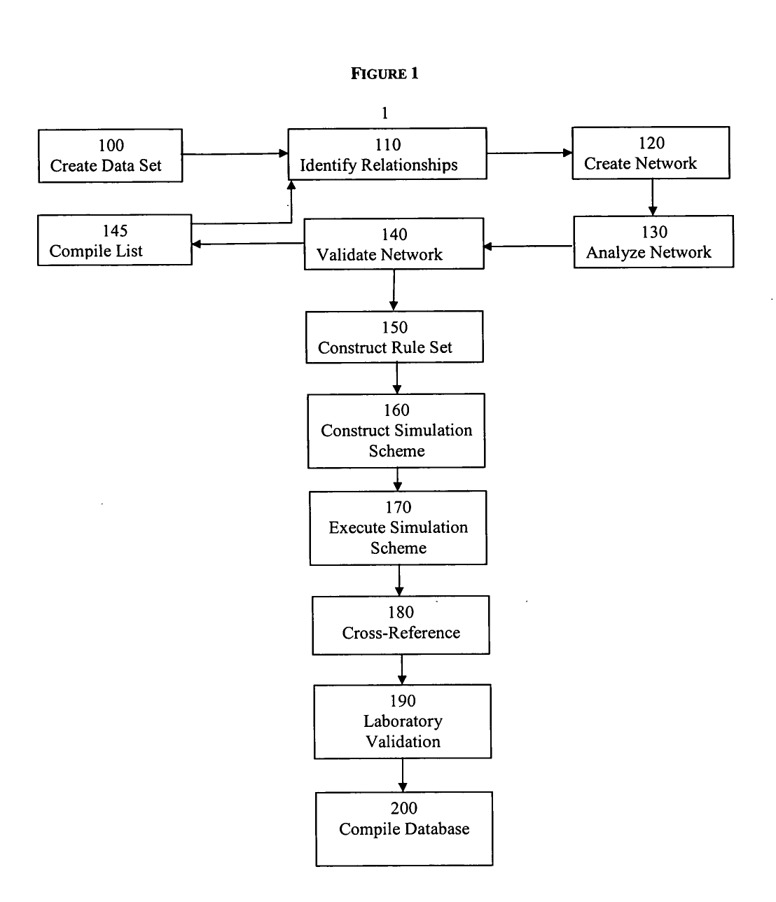

FIG. 1 illustrates a flow diagram of an embodiment of the method. In this embodiment, the first step 100 is to create or otherwise obtain a data set. In one embodiment, the data set can be obtained by exposing a biological model to the compound of interest. In one embodiment, the biological model may be an array of gene chips, such as those available from Affymetrix. In an embodiment, the data set comprises a variety of dosage levels and exposure times for the compound of interest to a gene chip array. In one embodiment, the data is an expression of mRNA.

The data obtained in step 100 is then used in step 110 to calculate and/or identify biological relationships. The relationships identified in this step may be, for example, relationships between and among genes, proteins, enzymes, metabolic pathways, etc.

In step 120, the data and identified relationships are used to create a network. In an embodiment, for example, the relationships identified in step 110 are combined with exhaustive clustering (gene against gene) to produce an accurate interaction network representing each gene that is affected by the compound under study.

The network created in step 120 is then analyzed in step 130 and, in step 140, is validated. In an embodiment, the analysis step 130 comprises calculating the non-linear correlation coefficients of combinations of genes from different dosages and exposure times in step 100.

In one embodiment, the validation of the network comprises a comparison of the network against standard network(s) produced by natural language searching of published literature. Interactions that cannot be validated are compiled into a list of predicted interactions in step 145. The list of predicted interactions is then fed back into the calculation/identification of biological relationships in step 110. Statistical analysis and confidence levels may also be determined as part of the validation.

In step 150, the validated interactions are used to construct an initial rule set. The rule set is then used to construct a simulation scheme in step 160. The simulation scheme is then executed in step 170. The simulation scheme may, in an embodiment, be a discrete simulation scheme such as cellular automata. A cellular automaton is a discrete model studied in computability theory, mathematics, theoretical biology and microstructure modeling. It consists of a regular grid of cells, each in one of a finite number of states. The grid can be in any finite number of dimensions. Time is also discrete, and the state of a cell at time t is a function of the states of a finite number of cells (called its neighborhood) at time t-1. These neighbors are a selection of cells relative to the specified cell, and do not change (though the cell itself may be in its neighborhood, it is not usually considered a neighbor). Every cell has the same rule for updating, based on the values in this neighborhood. Each time the rules are applied to the whole grid a new generation is created.

The result of execution step 170 is to create a hierarchy of genes that are affected by the compound and that control a significant portion of genes in the network. In the next step 180, the hierarchy of genes is then cross-referenced against the list of interactions that need to be validated. In step 190, any interactions that could not be validated via the bioinformatics pathway are validated in the laboratory. The final list of genes that have been validated represents all targets that are affected by the compound and could cause major physiological changes.

In an embodiment, the final list of validated genes and interactions is compiled in step 200 into a searchable database that includes strength of interactions resulting from compound introduction and genes regulated/controlled by the same compound. The database can then be used to facilitate refinement of the potential drug candidate, maximize the impact of the potential drug candidate, direct pre-clinical studies and provide other benefits in the drug development process.

While the method steps outlined above are particularly suited for use in identifying pharmacological activity of proposed drug compounds, it is to be understood that other uses of the method are also advantageous. For example, the process can be used to identify genetic markers, which information could then be used to develop new or improve existing therapies for particular diseases, or used to develop test procedures or test kits for particular diseases or biological conditions.

We claim:

1. A method comprising the combination of bioinformatics with laboratory validation.

2. A method comprising the steps of:
a) creating a network of gene interactions affected by said compound
b) analyzing the network to identify interactions that need validation;
c) simulating the validated interactions to create a hierarchy of genes and interactions with said compound;
d) comparing the simulation data against interactions that were not validated in step (c); and
e) performing laboratory validation of any interactions that were identified in step (e).

3. The method of claim 2, further comprising the step of generating said data set by exposing a biological model to said compound.

4. The method of claim 3, wherein said biological model comprises an array of gene chips.

5. The method of claim 2, wherein step (a) comprises creating said network by combining said non-linear correlation coefficients with exhaustive gene-against-gene clustering.

6. The method of claim 5, wherein step (b) comprises calculating non-linear correlation coefficients.

7. The method of claim 2, wherein step (c) comprises comparing the network of step (a) against a standard network created by natural language searching of published literature.

8. The method of claim 2, wherein step (d) comprises use of a discrete simulation scheme.

9. The method of claim 8, wherein said simulation scheme comprises cellular automata.

10. The method of claim 2, further comprising the step of compiling the validated genes and interactions data into a searchable computer database.

11. Use of the method of claim 10 to evaluate pharmacological behavior of a compound.
